(19) United States
(12) Patent Application Publication
(10) Pub. No.: US 2012/0316960 A1
(43) Pub. Date: Dec. 13, 2012

(54) RECOMMENDING SUPPLEMENTAL PRODUCTS BASED ON PAY-FOR-PERFORMANCE INFORMATION

(75) Inventor: Zhixiong Yang, Hangzhou (CN)

(73) Assignee: ALIBABA GROUP HOLDING LIMITED, George Town (KY)

(21) Appl. No.: 13/488,692

(22) Filed: Jun. 5, 2012

(30) Foreign Application Priority Data
Jun. 7, 2011 (CN) 201110150560.1

(51) Int. Cl. G06Q 30/02

(52) U.S. Cl. 705/14.53

(57) ABSTRACT

A method and system for determining products to recommend to a user is disclosed. One or more correlated products which are correlated to a product the user is currently interested in are determined. In the event that the number of one or more correlated products is less than the number of recommended products needed, one or more supplemental products are determined. The one or more supplemental products are determined based on a pay-for-performance measure based on pay-for-performance information and a non-pay-for-performance measure not based on pay-for-performance information. A set of recommended products is formed from the determined one or more correlated products and the determined one or more supplemental products and information pertaining to the set of recommended products is outputted.

### CROSS REFERENCE TO OTHER APPLICATIONS

This application claims priority to People's Republic of China Patent Application No. 201110150560.1 entitled A METHOD AND EQUIPMENT FOR PUSHING PRODUCT INFORMATION filed Jun. 7, 2011 which is incorporated herein by reference for all purposes.

### FIELD OF THE INVENTION

The present invention relates to the field of computer technology. In particular, it relates to a method and system for recommending products.

### BACKGROUND OF THE INVENTION

When a user browses various shopping websites, the shopping website will study the browsing history of a user on the shopping website, in order to determine the products that are of interest to the user. Then the shopping website will recommend some products to the user in order to generate more sales of products.

A typical process whereby the website determines recommended products and outputs them is as follows:

1) User's browsing history on the shopping website is used to determine the products of interest to the user. The user browsing history comprises webpages containing some product information the user has browsed, bookmarks of product information pages, and transactions the user completes concerning a product.

A log stored by the website is used to record the user's browsing activity. The log comprises all kinds of activities by the user. The user's browsing activity is analyzed to determine the set of products which interest the client. For example, products associated with the pages browsed and bookmarked by the user are products that interest the client. Products involved in transactions can also be regarded as products which interest the client.

2) Determine other products related to products that interest the user as products to recommend to the user, based on product information correlations. The correlation of product information indicates the similarity of products. For example, within products that belong to the same subcategory, products with high similarity of product names are considered to be products related to products that interest the user.

3) If the quantity of related products that interest the user is relatively small, then the recommended products may be supplemented with other products. Supplementing with other products is determined using a measure of the product's product information. Other products in subcategories of the products of interest to the user can also be used as additional products to recommend to the user. To insure that the product information that is recommended to the user is helpful for the user's understanding of the products, the product information can be ranked according to a measure of the product information. A measure that brings forth products that are superior can be used. One measure of products could be product sales volume, product shelf time, or popularity of a product, etc.

4) Output the required quantity of recommended product information to the user. Each piece of information that is specifically outputted or pushed contains the following: product name, price, seller name, whether the seller-requested instant messenger account is online, the Uniform Resource Locator (URL) for the product information, etc.

Additionally, the shopping website can contain P4P products. P4P stands for Pay for Performance (or “pay-for-performance”), which is a form of internet marketing of products on the shopping website. Sellers can bid according to key words associated with the products they are selling. After a bid wins, products that correspond to the key word are P4P products. When a user browsing the shopping website searches by a keyword corresponding to P4P product and clicks and browses the corresponding P4P product information webpages, the seller pays a fee for each click.

When the shopping website sends information to the user, it also needs to send P4P products in addition to the conventional products on the shopping website (products that are not P4P products or do not have a pay-per-click link). The website outputs P4P products according to the following method:

1) Determine the products of interest to the user based on the user's browsing and then determine a key word for the P4P product search. The determined key word is related to the products of interest to the user.

2) Search for P4P products in advertising system based on the key word. Then determine the P4P product information, including the pay-per-click link associated with the P4P product. As used herein, the pay-per-click link or URL of the determined P4P product information is linked to the fee-charging system and is referred to as a eURL.

3) If the quantity of P4P products that is to be outputted to the user is relatively small, then the product information may be supplemented with other products. Supplementing with other products here is done in a similar way as the supplementing of related products with conventional products, except that the P4P products are supplemented with information in the advertising system or other P4P products.

4) Output the required quantity of P4P products to the user.

Currently, it is possible to output only conventional product information or output only P4P product information when recommending products because of the different system that the P4P products are located on (i.e. the advertising system). It is possible to output conventional product information and P4P product information as recommended products but according to a fixed ratio. Generally, on a shopping website the quantity of P4P products is generally far less than the quantity of conventional products. Therefore, if recommended products are suggested using a fixed ratio of P4P products, there might be an excess of P4P product information that is useless to the user. The effectiveness of the recommended products section on a shopping website is then reduced. If there is too little P4P product information in the recommend products section, then the website will fail to achieve its objective of generating P4P product revenue.

Moreover, when outputting conventional product information and P4P product information in a fixed ratio, currently two searches need to be performed: one search to determine the conventional product information to recommend to the user and another search to determine the P4P product information to recommend to the user. In other words, the system needs to additionally allocate resources for determining P4P products to recommend to the user.

### BRIEF DESCRIPTION OF THE DRAWINGS

Various embodiments of the invention are disclosed in the following detailed description and the accompanying drawings.

FIG. 1 is a diagram illustrating an embodiment of an environment for an embodiment of a system for determining recommended products.

FIG. 2 is a block diagram illustrating an embodiment of a system configured for determining recommended products.

FIG. 3 is a flow chart of an embodiment of a method of selecting recommended products on an e-commerce website.

FIG. 4 is a flow chart illustrating an embodiment of determining supplemental products.

FIG. 5A is a flowchart of an embodiment of a method for determining categories the user is interested in based on the user's browsing history.

FIG. 5B is an embodiment of a time exponential decay function used to weight a user interest score.

FIG. 6 is a block diagram illustrating an embodiment of a method of determining a content quality score for a product.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A method and system for determining products to recommend to a user that includes pay-for-performance (e.g., pay-per-click, pay-per-purchase) products is disclosed. Pay-for-performance products on an e-commerce website comprise products that are specifically advertised by a seller on the e-commerce website. In some embodiments, the seller pays a fee for each click by a potential buyer on a link to an advertised product and/or each transaction (e.g., placing the product in a shopping cart, actually purchasing the product) made via the link. In order to determine products to recommend to a user on an e-commerce website, a product the user is currently interested in is determined based on the user's browsing history. Then one or more correlated products are determined that are correlated with the determined product the user is currently interested in. In some embodiments, the number of one or more correlated products is less than a certain number of recommended products that are need. For example, on the home page of an e-commerce website there is room to display a list of 10 recommended products, but the number of correlated products found when looking for products to recommend is only 3. In the event that the number of one or more correlated products is less than the number of recommended products needed, supplemental products are determined.

In some embodiments, supplemental products are products that are within the categories that the user is currently interested in and have a high content quality. Supplemental products can include pay-for-performance products that are also promoted. For example, if a user is determined to have been interested in laptops and backpacks in the last month, then popular products from these categories are selected and form the group of recommended products (along with the correlated products). In some embodiments, the supplemental products are selected based on a content quality score that is based on a pay-for-performance measure and a non-pay-for-performance measure.

In some embodiments, a pay-for-performance measure represents the length of time an available product has been a pay-for-performance product, and the popularity or effectiveness of products that are being advertised. In some embodiments, when selecting supplemental products, pay-for-performance products are given a higher weight through the pay-for-performance measure (which is used to calculate the content quality score). In some embodiments, a non-pay-for-performance measure comprises a measure of the quality of the product information (e.g. completeness of product information, number of pictures, lack of typographic errors in product description, etc.). In some embodiments, a non-pay-for-performance measure comprises a frequency of accesses of the product information, indicating a more popular product.

Therefore when recommending products, pay-for-performance products along with higher content quality are factored in and featured in the list of recommended products. Lists of recommended products are displayed on the home page of an e-commerce website or on a product information page, or a page displaying the shopping cart of the e-commerce website.

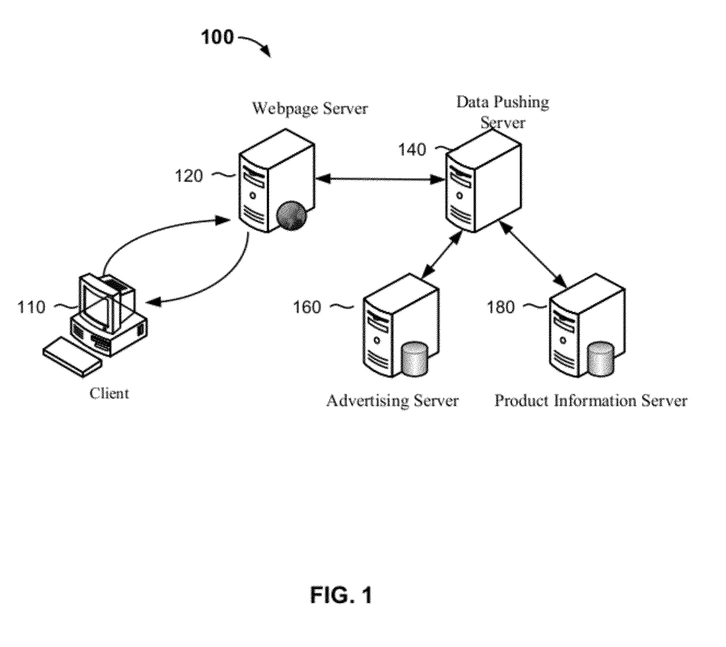

FIG. 1 is a diagram illustrating an embodiment of an environment for an embodiment of a system for determining recommended products. A user using client 110 (e.g. a personal computer) accesses a webpage through a web browser that is sent over the internet (e.g. a wireless network, a computer network, or a combination) by webpage server 120. In some embodiments, client 110 is an internet enabled mobile device with a web browser. In some embodiments, the webpage contains content that is generated asynchronously. In some embodiments, the user is browsing an e-commerce website and content is pulled from webpage server 120, data pushing server 140, advertising server 160 and product information server 180. In some embodiments, recommended products are pushed asynchronously to the webpage using data pushing server 140 while the user is browsing the e-commerce website. In some embodiments, data pushing server 140 determines a set of recommend products to push to the client. In some embodiments, webpage server 120 and data pushing server 140 are the same server and webpage server 120 generates webpages and determines a set of recommended products and outputs them to the client. In some embodiments, webpage server 120, data pushing server 140, advertising server 160 and product information server 180 are implemented on a LINUX network system architecture.

In some embodiments, a user on client 110 browses a website served by webpage server 120, which keeps track of user browsing activity using a cookie in the user's browser. In some embodiments, a user logs into their account with a user id (e.g. username) and the web page server 120 keeps track of the user's browsing activity using the user id. Other forms of identifying a visitor to the website tied to different end-points can be used like web browser unique identifiers, client machine identifiers, MAC addresses, etc.

In some embodiments, the website page includes Asynchronous Javascript and XML (AJAX) code that contains an embedded XMLHttpRequest object which opens a connection to webpage server 120 in communication with the data pushing server. In some embodiments, the webpage includes source code that submits a request (e.g. AJAX Request) using the web browser in order to exchange data asynchronously (e.g. without a full-page reload, or without loading a new page) with 120 webpage server and data pushing server 140. In some embodiments, the request carries a user or client identifier. In some embodiments, determined recommended products are pushed asynchronously to client 110 in the JavaScript Object Notation (JSON) format. JSON is a human readable text based data format for serializing information. Then the webpage contains source code (e.g. Javascript code) to gather the data from the JSON data, and format the data so the web browser can display the recommended products to the user.

In some embodiments, data pushing server 140, after forming a set of recommended products to the user, obtains product information (e.g. description, title, price, etc.) from product information server 180 or pay-for-performance information from advertising server 160. In some embodiments advertising server 160 maintains a database of pay-for-performance information. In some embodiments, pay-for-performance information comprises a eURL which is a fee-charging link. In some embodiments, pay-for-performance comprises a pay-per-transaction tag. A fee-charging link or pay-per-transaction tag is linked to a component of the advertising system that charges a fee (e.g. actual money or virtual currency/points) to the seller's account. In some embodiments, advertising server 160 also handles charging seller accounts for each click of the pay-per-click product or for each transaction of a pay-per-transaction product. In some embodiments, pay-for-performance information also comprises the status of pay-for-performance products. Pay-for-performance products are products that are associated with a key word that a seller has bided on and won. A database of all currently valid fee-charging links is maintained. In some embodiments, a pay-for-performance product also has a budget of advertising fees set by the seller. When a pay-for-performance product has exhausted its budget, then the pay-for-performance product is “offline” and becomes a non-pay-for-performance product (e.g. a conventional product) again.

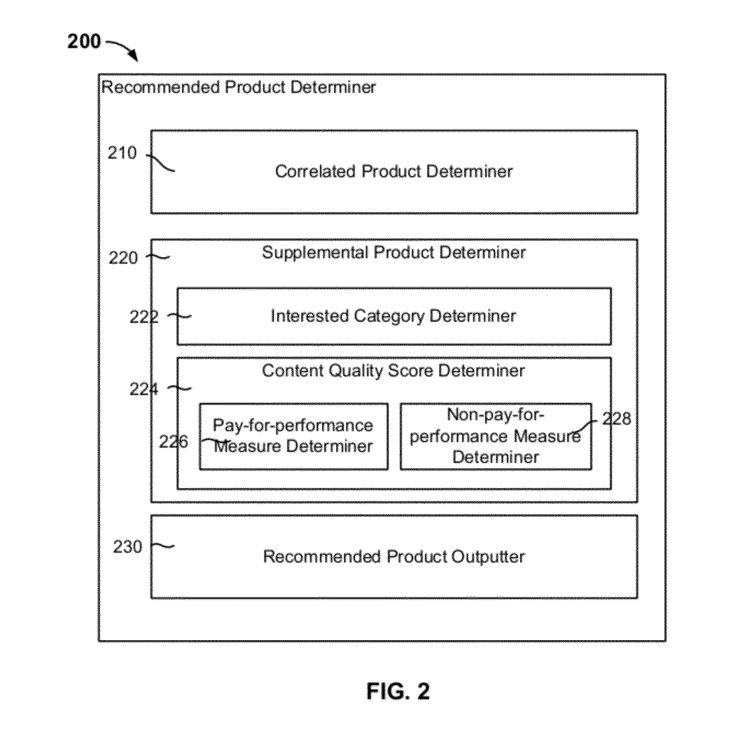

FIG. 2 is a block diagram illustrating an embodiment of a system configured for determining recommended products. Recommended product determiner 200 determines a set of recommended products. In some embodiments, the recommended product determiner comprises correlated product determiner 210, supplemental product determiner 220, and recommended product outputter 230. In some embodiments, the recommended product determiner chooses a set of products from correlated product determiner 210 and supplemental product determiner 220 as recommended products. In some embodiments, recommended product determiner 200 chooses products from supplemental product determiner 220 when the number of correlated products determined is not sufficient. A number of recommended products are needed, and if the determined number of correlated products is less than the number of recommended products needed, supplemental products are determined to make up the difference.

In some embodiments, correlated product determiner 210 also determines a product that the user is currently interested in. In some embodiments, supplemental product determiner 220 also includes interested category determiner 222 and content quality score determiner 224. In some embodiments, in order to determine a set of supplemental products, interested category determiner 222 determines one or more categories the user is currently interested in, based on the user's browsing history. In some embodiments, in order to determine a set of supplemental products, content quality score determiner 224 determines a content quality score for each product. In some embodiments, content quality score determiner 224 includes pay-for-performance measure determiner 226 and non-pay-for-performance measure determiner 228. In some embodiments, content quality score determiner 224 determines the content quality score for an available product based on a pay-for-performance measure from pay-for-performance measure determiner 226 and based on a non-pay-for-performance measure from non-pay-for-performance measure determiner 228. Pay-for-performance measure determiner 226 determines a pay-for-performance measure for a pay-for-performance product. For example, a pay-for-performance measure comprises the amount of fees generated from a pay-for-performance product while the product has been a pay-for-performance product. Non-pay-for-performance measure determiner 228 determines a non-pay-for-performance measure of an available product, which is not related to advertising. For example, the frequency of page accesses of a product information page is a non-pay-for-performance measure.

Recommended product determiner 200 also includes recommended product outputter 230. In some embodiments, recommended product outputter 230 takes the determined set of recommended products and formats and outputs the recommended products. In some embodiments, the recommended products are formatted to be displayed to the user in a web application. In some embodiments, the set of recommended products is formatted into JSON format and a subset of the product information of the recommended products is sent to a web browser to be displayed.

The units of recommended product determiner 200 in FIG. 2 can be implemented as one software component or several software components. The units and sub-units of FIG. 2 can also be implemented as software components on separate devices, or a combination of devices. In some embodiments, units of recommended product determiner 200 are implemented as web services or web applications in a cloud. In some embodiments, one or more of the units of FIG. 2 are implemented as database scripts or database methods. Although units in FIG. 2. seem to indicate a hierarchy or indicate a unit is a subunit, the units or subunits may not necessarily always behave in that manner, but also enjoy privileges of the units above them.

System 100 and recommended determiner 200 may be implemented using one or more computing devices such as a personal computer, a server computer, a handheld or portable device, a flat panel device, a multi-processor system, a microprocessor based system, a set-top box, a programmable consumer electronic device, a network PC, a minicomputer, a large-scale computer, a special purpose device, a distributed computing environment including any of the foregoing systems or devices, or other hardware/software/firmware combination that includes one or more processors, and memory coupled to the processors and configured to provide the processors with instructions.

The units or blocks described above can be implemented as software components executing on one or more general purpose processors, as hardware such as programmable logic devices, and/or Application Specific Integrated Circuits designed to perform certain functions or a combination thereof. In some embodiments, the units can be embodied by a form of software product which can be stored in a nonvolatile storage medium (such as optical disk, flash storage device, mobile hard disk, etc.), including a number of instructions for making a computer device (such as personal computers, servers, network equipments, etc.) implement the methods described in the embodiments of the present invention. The units may be implemented on a single device or distributed across multiple devices. The functions of the units may be merged into one another or further split into multiple sub-units.

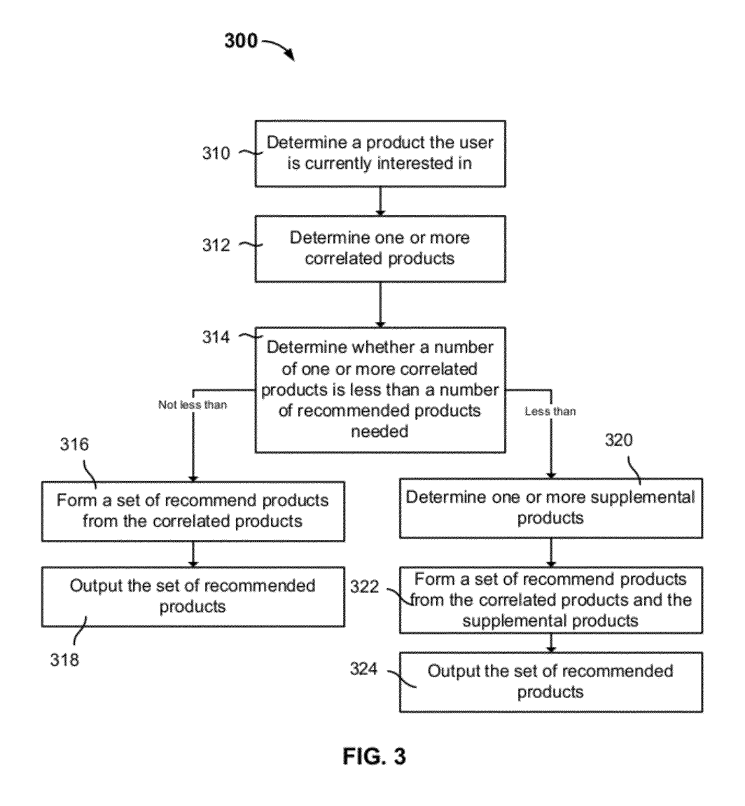

FIG. 3 is a flow chart of an embodiment of a method of selecting recommended products on an e-commerce website. At least a portion of 300 is performed by webpage server 110 or data pushing server 140 of FIG. 1, or recommended product determiner 200 of FIG. 2. At 310, a product the user is currently interested in is determined. In some embodiments, the determination is made based at least in part on a browsing history of the user. In some embodiments, a log of the browsing history of a user is examined to determine the product the user is currently interested in. In some embodiments, one or more of the following factors in the user's browsing history are examined to determine the product the user is currently interested in: user browsing activities, user browsing activity frequencies, products in the user browsing history. User browsing activities that are kept track of in the user's browsing history include one or more of the following: pages and products browsed, product information that was used, pages and products bookmarked, if a seller's instant messaging status was checked, if a seller was instant messaged, products purchased, or what product information webpages were published and under what category (for sellers on the e-commerce website). For example, when a user accesses an e-commerce website, the user clicked and browsed 3 webpages; the content of each webpage was product information for one product. Therefore, the log of the user's browsing history indicates client browsing activity comprising of: browsed product web page A; frequency of browsing activity—3 times, and product information used includes product information 1, product information 2, and product information 3.

In some embodiments, the last product that the user has looked at is the product the user is currently interested in. In some embodiments, the last product involved in a transaction is the product the user is currently interested in. For example, a user has just added a green mug to the shopping cart; therefore the green mug is determined to be product the user is currently interested in. In some embodiments, a product within a predetermined time length from the current time is the product the user is currently interested in. For example, within the last 3 days of the current website access, the user bookmarked a laptop.

At 312, one or more correlated products are determined. In some embodiments, correlated products are products that have a high correlation factor with the product the user is currently interested in. In some embodiments, correlation comprises a relationship determined through various user behaviors (e.g., previous buying history on the website). In some embodiments, a database of relationships of products that are frequently bought together is kept and each relationship is represented by a correlation factor. For example, the green mug the user is currently interested in is often bought with a set of green plates, or a coffee maker. In some embodiments, correlation is based on the similarity of the content of the product information with other products. For example, the product information of the green mug the user is currently interested in contains several descriptors including: mug, a brand name, a size, green, etc. that can be used to find other products that are similar. A similarity measure is determined between the product of current interest and other products in a product database and those above a threshold are selected as correlated products. In some embodiments, one or more keywords in the product information of the product the user is currently interested in are used to find correlated products. For example, the keyword “mug” from the product information of the green mug is used to find other correlated products. The determined correlated products can be pay-for-performance products (i.e. advertised products) or conventional products as long as they are products in the database that is searched. Other correlation measures or factors can be used to determine correlation with the product of interest with other products.

In some embodiments, the correlated products are determined one at a time as the product information database is being searched (i.e. a list is created of products above the correlation threshold as the product information database is searched), and the products above the correlation threshold within a time frame are determined to be the correlated products. The product information database could have tens of millions of products and the purpose of having recommended products on a webpage would be defeated if the user had to wait for 10 minutes to see recommended products. For example, the product information database is searched for 10 ms after the user loads the product info webpage on the e-commerce website with the recommended products list and the products above the correlation threshold found within the 10 ms time frame are determined to be the correlated products.

In some embodiments, the correlation threshold is set to be very stringent (e.g. very high) so only a few products are determined to be correlated to the current user product and sent to the user as recommended products. Therefore the recommended products are more likely to be of interest to the user. In some embodiments, the product that the user is currently interested is unique enough to not have many products to be correlated to it, or similar to it. In some embodiments, the number of correlated products found within a time frame is very low because of server backlog or network congestion.

At 314, whether a number of correlated products are less than the number of recommended products needed is determined. In some embodiments, the number of recommended products needed is set by the user. For example, in a user preferences section of a website, the user can set that they would like 10 recommended products to be displayed. In some embodiments, the number of recommended products needed is set by the website designer. For example, the home page of an e-commerce website has a recommend products list for a user when they return back to the e-commerce website. The recommend products list needs 10 products to be displayed on the home page.

At 316, in the event that the number of correlated products is greater than or equal to (i.e. not less than) the number of recommended products, a set of recommend products is formed from the determined correlated products, wherein the number of determined correlated products selected is a number equal to the number of recommended products needed. In some embodiments, the one or more products determined to be correlated (i.e. above the correlation threshold) have a ranking of correlation, and the top number of correlated products equal to the number of products needed is selected. In some embodiments, when the correlated products are determined one at a time as the product information database is being searched, the correlated products that were determined first are selected as the recommended products.

At 320, in the event that the number of correlated products is less than the number of recommended products needed, then one or more supplemental products are determined. Supplemental products include products that are of interest to the user and products that are of high content quality. Content quality is made up of a pay-for-click measure and a non-pay-for-click measure. In some embodiments, supplemental products are selected from the same category as the product the user is currently interested in. In some embodiments, the user's browsing history is examined to determine in the recent history a set of categories that the user is interested in and supplemental products are selected from those categories. In some embodiments, products that have high content quality are products that are being advertised by a seller and are pay-for-performance products. In some embodiments, high content quality comprises products that are popular on the e-commerce website, which is a non-pay-for-click measure.

At 322, a set of recommended products from the correlated products and the supplemental products is formed. The number of supplemental products to select is the number of recommend products needed minus the number of correlated products determined. In some embodiments, when determining one or more supplemental products, the exact number of supplemental products needed is determined and are added to the correlated products to form the set of recommended products. In some embodiments, a number of supplemental products are determined that is more than the amount needed and the determined supplemental products selected are from the top of the ordered list of determined supplemental products. In some embodiments, the determined supplemental list is ordered by ranking the content quality score of each product.

In some embodiments, no correlated products are found and the set of recommended products comprises of supplemental products. Supplemental products are determined according to the content quality score. In some embodiments, correlated products are not determined, and the set of recommended products comprises only of supplemental products. In some embodiments, forming a set of recommended products comprises determining one or more supplemental products based at least in part on a pay-for-performance measure and a non-pay-for-performance measure. In some embodiments, forming a set of recommended products comprises determining one or more supplemental products based at least in part on a pay-for-performance measure and a non-pay-for-performance measure and based on the user's browsing history.

At 318 and 324, the set of recommended products is outputted. In some embodiments, the selected recommended products in 316 or 322 is a list of product ID's. In some embodiments, product information of the recommended product is pulled from the product information database (e.g. a database on product information server 180 of FIG. 1) according to the product ID. In some embodiments, a subset of the product information from the product information database including product name, price, pictures, name of seller, seller's instant messaging account online status, and URL is pulled. In some embodiments, pay-for-performance products are also stored in the product information database, with the exception that the URL of the product (e.g. the link to the product information page) is a normal URL and is not a eURL. Other product information or subsets of product information can be pulled from the product information database to make up the information needed for displaying the recommended product.

From the set of recommend products, if a recommended product is a pay-per-click product, then a eURL is needed to be obtained from the database of pay-for-performance information. If a recommended product is a pay-per-transaction product, a pay-per-performance tag also needs to be obtained from the database of pay-per-performance information. In some embodiments, the product ID's of the set of recommended products are searched for in the database of pay-for-performance information, and an eURL is returned for the recommended products which have active eURL links and replaces the URL from the product information database. In some embodiments, pay-per-click product is active if the eURL is in the database of pay-for-performance information.

In some embodiments, product information of the set of recommended products is obtained from the product information database in communication with the product information server (e.g. 180 of FIG. 1) and pay-for-performance information including the eURL of any active pay-per-click products is obtained and pay-per-transaction tags of any active pay-per-transaction products from the database of pay-for-performance information maintained by the advertising server (e.g. 160 of FIG. 1). Then the product information and the pay-for-performance information is combined and formatted by the data pushing server (e.g. 120 of FIG. 1) or webpage server (e.g. 120 of FIG. 1) and outputted. In some embodiments, the product information of each product of the set of recommend products is formatted into JSON format and pushed to the webpage on the client device through an asynchronous connection open with the webpage server (e.g. 120 of FIG. 1). In some embodiments, the advertising server (e.g. 160 of FIG. 1) also has a copy of the non-pay-for-performance information (i.e. product information contained in product information database) for pay-for-performance products. In some embodiments, the advertising server also has access to the product information database. In some embodiments, the database of pay-for-performance information is queried first and then the product information database.

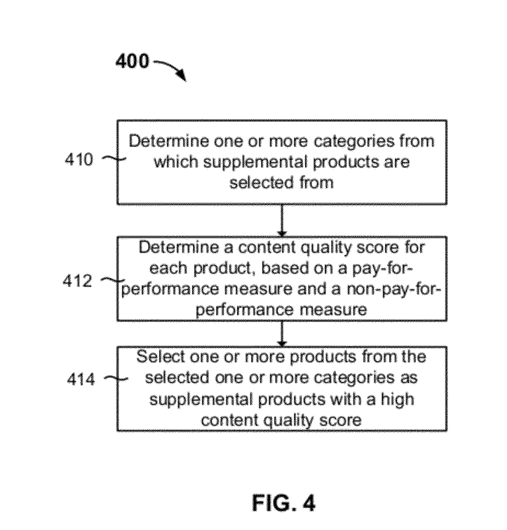

FIG. 4 is a flow chart illustrating an embodiment of determining supplemental products. At least a portion of 400 is done by data pushing server 140 or webpage server 120 of FIG. 1 or supplemental product determiner 220 of FIG. 2. At least a portion of 400 is performed when 320 of method 300 is performed.

At 410, one or more categories from which supplemental products are selected from are determined. In some embodiments, supplemental products are selected from the same category as the category of the product the user is currently interested in (i.e. the product that was used to determine correlated products). In some embodiments, the category of the product the user is currently interested in and similar categories are determined for selecting supplemental products from. In some embodiments, the user's browsing history is examined to determine in the recent history a set of categories that the user is interested in and supplemental products are selected from those categories. In some embodiments, in order to determine the set of categories the user is currently interested in, the browsing history of the user that is examined is even further back in time than the user browsing history used to determine the product the user is currently interested in (and used for determining the correlated products). In some embodiments, a determination of categories the user is currently interested in is done when there are not enough correlated products to recommend (i.e. when supplemental products need to be determined).

In some embodiments, a category user interest score for each category is determined and ranked. Then the top categories with the highest user interest score are selected to choose supplemental products from. In some embodiments, the user interest score for each category is calculated based on predetermined portion of the user's browsing history. In some embodiments, a predetermined number of categories (e.g. 3 categories) from the categories ranked by user interest score are selected. For example, the user's browsing activity in the last month contains all sorts of products including laptops, gardening equipment, baby diapers, backpacks, and basketball jerseys. The categories are ranked by user interest score and the top 3 are selected. The highest user interest (indicated by the category having the highest user interest score) is basketball jerseys. To entice the user to buy other products he or she may have been interested in, the category of laptops (which had the second highest user interest score) and backpacks (third on the list) is also selected.

At 412, a content quality score for each product, based on a pay-for-performance measure and a non-pay-for-performance measure, is determined. In some embodiments, a pay-for-performance measure includes a measure of how long the product has been a pay-for-performance product. In some embodiments, a pay-for-performance measure is the amount of fees generated by the pay-for-performance product.

In some embodiments, a non-pay-for-performance measure comprises measure of a product on the e-commerce website not related to pay-for-performance or advertising. One or more of the following measures is calculated: quality of the product information, frequency of accesses of the product information, time length since the product information has been published, rating of the seller that published the product information. In some embodiments, the non-pay-per click measures comprise measures of the popularity of the product (e.g. a “hot” product). Other non-pay-for-performance measures can also be used. In some embodiments, the pay-for-performance measures and the non-pay-for-performance measures are combined together in a weighted sum to make a content quality score.

In some embodiments, the content quality score is calculated prior to the determination of supplemental products and is stored in a database. In some embodiments, the content quality score is calculated for each product and stored in the product information database, or in a database correlated with the product information database. In some embodiments, the content quality scores are updated periodically. In some embodiments, the content quality score is calculated after a category is determined to select supplemental products from. In some embodiments, content quality scores of products are determined when the product's pay-for-performance status changes, for example, when a seller makes a product an active pay-for-performance product.

At 414, from the selected one or more categories, one or more products with high content quality scores are selected as supplemental products. In some embodiments, the content quality scores of the products from each of the one or more selected categories are ranked and a set number of the products with the highest content quality are selected as supplemental products. For example, two pay-for-performance advertised laptops are selected and recommended to the user, along with two of the more popular grocery products. In some embodiments, products with a content quality scores above a threshold are selected from each category in the list of categories ranked by user interest until the number of recommended products needed is reached (where the recommended products already includes the correlated products). It can be seen that by providing variety in the recommended product section of the webpage, products that buyers might want to buy are recommended. Especially in the shopping cart area, where a user has already decided to buy a product, they might not want another similar product. Because an advertised product is not just recommended because it is advertised, but weighted in with a content quality score, and selected from categories that the user is interested in, a set of products that better suits the customer's needs is presented. This encourages a higher click-through of advertised products and generates revenue for the e-commerce website.

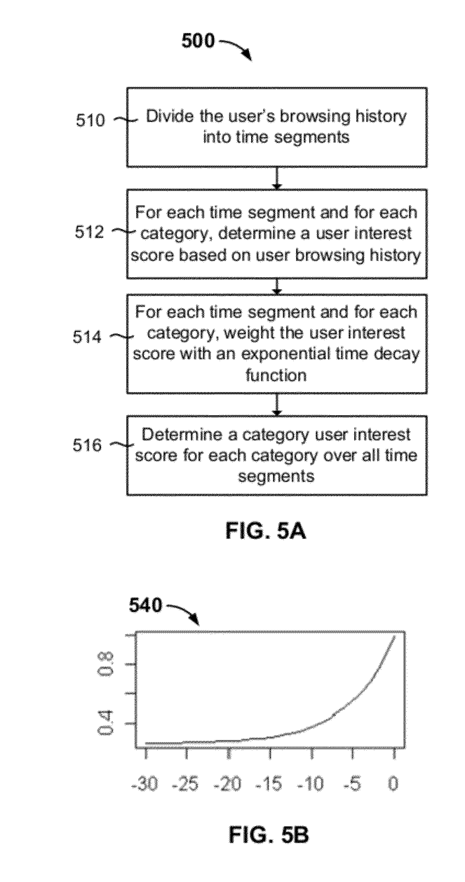

FIG. 5A is a flowchart of an embodiment of a method for determining categories the user is interested in based on the user's browsing history. In some embodiments, the method of 500 is performed when 410 of method 400 in FIG. 4 is performed. At 510, the user's browsing history for a predetermined duration is divided into time segments. In some embodiments, a log is kept by the website of the user's browsing history, and only a predetermined duration is used in calculating the user's interest in a category. For example, the user's browsing history for the last 30 days is divided into 30 segments, each consisting of 1 day. A user's interest in products may change frequently, for example, products that are of interest to the user 1 week ago are not interesting to the user 1 week later. In some embodiments, the user's browsing history is divided so that the user's interest seems to stay the same within each time segment. Other divisions of the predetermined duration of browsing history can also be used, to a desired granularity of the user's interest.

At 512, for each time segment and for each category, a user interest score is determined based on the user's browsing history. In some embodiments, the user interest score is determined for the categories of the products which are in the user's browsing history for the predetermined duration. In some embodiments, each product in the user's browsing history belongs to many categories and a separate user interest score is calculated for each category. In some embodiments, the user interest score is determined for all categories in the website.

In some embodiments, the user interest score is determined based on the types of browsing activity and the number of occurrences of each type of browsing activity for each category and for each time segment.

In some embodiments, each type of activity is weighted. Different activities can represent different levels of user interest in the category. A weight for each type of activity is set in order to indicate the level of user interest reflected by the activity. For example, a user browsed and looked at the product info, bookmarked the product, then looked at the product info, and then finally bought the product. The activity weight of the browsing (or looking at the product info) is determined to be w1, the activity weight of the bookmarking is w2, and the activity weight of the transaction is w3. Generally, the level of interest in product information indicated by a user looking at the product information webpage is not necessarily very high. However, the user is very likely to be interested in a product which has been bookmarked or used in a transaction. Therefore, the activity weights are set as the following: w2=w3>w1.

In some embodiments, the number of occurrences of each type of activity in each category is factored into the user interest score for each time segment and for each category. The number of occurrences within a time segment is also the frequency of each user activity. In some embodiments, the log of user browsing history is looked at to determine the number of occurrences of each type of activity during time segment i and in category j. For example, the log of user browsing history is looked at to determine the number of pages browsed (e.g. product information page loads) represented as variable x1, the number times products were bookmarked (e.g. clicking a bookmarking link) represented as variable x2, and the number of transactions and involving what products, represented as variable x3.

Table 1 summarizes the variables used in an embodiment of the user interest score calculation.

| Activity | Weight | Number of occurrences |
|---|---|---|
| Browse | wl | xl |
| Bookmark | w2 | x2 |
| Transaction | w3 | x3 |

Therefore, the formula for user interest score, Yᵢⱼ, in the i^{th} time segment (or time segment i) and category j combining the activity weight and the number of occurrences of each type of activity is:

Yᵢⱼ=w₁₁*x₁; + . . . +wₙⱼ*xₙⱼ (1)

where: w₁ⱼ and wₙⱼ represent the activity weights of activity types 1 through n by the user in category j; x₁ⱼ and xₙⱼ represent the number of occurrences of activity types 1 through n by the user in category j.

At 514, the user interest score in each time segment and for each category is weighted with an exponential time decay function. The exponential time decay function multiplied into the user interest score represents a decaying interest in a category as time passes. Categories which the user has preference for during the oldest days of a 30-day user browsing history may differ greatly from the categories the user is interested in during the most recent days. For example, a user's preference for a dress in the spring fashions category diminishes as time passes; the dress looked at today may not be dress that the buyer is interested in two weeks later. Two weeks later, the category the buyer is interested in has changed to shoes. The categories in the most recent days of the user's browsing history better reflect the actual preferences of the user.

An exponential time decay function, P(t), as time passes, can be expressed with formula (2):

P(t)=K₁+(exp(−t−K₂)/K₃) (2)

where: K₁, K₂ and K₃ represent preset constants. The constants K₁, K₂ and K₃ are determined depending on different situations of the data or differences in the data in order to obtain an exponential time decay curve needed for representing decaying user interest over time. For example, an embodiment of the exponential time decay function of formula 2 is plotted in FIG. 5B. Time decay weighting function 540 is scaled to match a user browsing history with 30 days and divided into 30 segments of 1 day each. In time decay weighting function 540, the time segment for 30 days ago is time segment 30, the time segment for 29 days ago is time segment 29, etc. The time segment of the most recent day, time segment 1, has a higher weight at 0.98 than time segment 20, with a weight of 0.3.

Then the user interest score, Qᵢⱼ, for time segment i and category j after being weighted with the exponential time decay function is:

Qᵢⱼ=P(i)ⱼ*Yᵢⱼ, where P(i)ⱼ is the exponential time decay weight for category j when t=i; and Yᵢⱼ is the user interest score based on user browsing history obtained at 512.

In some embodiments, the exponential time decay weight, P(i)ⱼ, is the left value of time segment (e.g. for time segment 1, the time decay weight is taken to be the left edge of the exponential time decay function, at 0.8), or the right edge of the time decay function (e.g. for time segment 1, the time decay weight is taken to be the right edge of the exponential time decay function, at 0.98), or the middle point of the time decay function for a time segment can also be used.

At 516, a category user interest score is determined for each category over all time segments. In some embodiments, time segments of the predetermined duration of the user browsing history (i.e. the portions of the user's history that is considered in the user interest score) are summed in each category to determine the category user interest score. In some embodiments, only user interest scores weighted with the time decay function that pass a pre-determined threshold are summed. For example, if the user interest score in day 20 (i.e. 20 days ago) in the laptop category is 2.4 (e.g. composed of 3 laptop product information pages looked at, with an activity weight of 0.5 for browsing and 1 laptop product bookmarked, with an activity weight of 0.9), then after weighting with the exponential time decay function (e.g. using graph 540, the exponential time decay weight is 0.2), the user interest score for day 20 is 0.48. If a threshold is set at 1, then day 20's user interest score would not be summed into the category fuser interest score. If the time decay weighted user interest score for day 20 was 1.5 because of some heavy user activity in a category, then the user interest score would be summed into the category user interest score for that category.

The category user interest score over all time segments for category j, V(j), is obtained using formula (3):

V(j)=P(1j)*Y₁ⱼ+ . . . +P(Mj)*Y_{Mj} (3)

where: M time segments in the user browsing history; user interest in category j in each time segment is Yᵢⱼ to Y_{Mj}; P(1j) to P(Mj) is the exponential time decay weighting for the 1 to M time segments. In some embodiments, each of the P(Mj)*Y_{Mj} terms (i.e. Qᵢⱼ from 514 or time decay weighted user interest scores for category j in time segment M) is filtered using a threshold before being summed into the overall user interest score.

The calculation of the category user interest score is repeated for each of the categories being considered. In some embodiments, a category user interest score for every category in the website is calculated using the user browsing history. In some embodiments, category user interest score is calculated for the categories of products within the user browsing history.

In some embodiments, a higher value of the category user interest score indicates a user is very interested in a category. A lower user interest score then represents lack of interest in a category. In some embodiments, weights and scales are applied to the user browsing history so that a lower value indicates a high user interest in a category. Accordingly, then the user interest scores for each category are ranked, and a number of the categories are selected to choose supplemental products from.

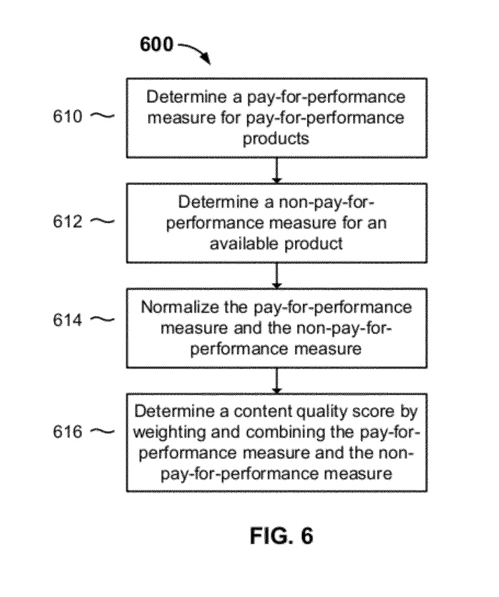

FIG. 6 is a block diagram illustrating an embodiment of a method of determining a content quality score for a product. In some embodiments, the method of 600 is performed when 412 of method 400 in FIG. 4 is performed. In some embodiments, the content quality score is based on a pay-for-performance measure and a non-pay-for-performance measure. In some embodiments, a portion of the total products available on the website have content quality scores calculated. In some embodiments, the content quality scores are calculated when they are needed (i.e. to determine supplemental product information).

At 610, a pay-for-performance measure is determined for pay-for-performance products. In some embodiments, a pay-for-performance measure includes a measure of how long the product has been a pay-for-performance product, also called pay-for-performance lifetime. Pay-for-performance lifetime is calculated by dividing the amount of time the product (and its product information) has been published (i.e. length of time the product was available) by the amount of time the product has been an active pay-for-performance product. The amount of time the product has been an active pay-for-performance product is time elapsed from the time the product was made into a pay-for-performance product to the current time. In some embodiments, a pay-for-performance measure is the quantity of fees generated by the pay-for-performance product while it was on the e-commerce website. The amount of fees generated (e.g. in monetary units, or in a generic unit) is divided by the amount of time the product has been made available (or the product information was published) on the e-commerce website. Other time frames that measure the product's lifespan on the e-commerce website can also be used.

At 612, a non-pay-for-performance measure is determined for an available product. Available products are products in the product information database or pay-for-performance database and available to be recommended to the user. A non-pay-for-performance measure comprises measures not related to pay-for-performance or advertising. A non-pay-for-performance measure is calculated for pay-for-performance products as well as conventional products. In some embodiments, a non-pay-for-performance measure comprises a score of the quality of the product information. In some embodiments, the product information is given a score based on the completeness of the product information, typographical errors, number of pictures of the product, etc. In some marketplace websites (a type of e-commerce website), the product information is entered by independent sellers and therefore the format or amount of information provided varies greatly.

In some embodiments, the frequency of accesses of the product information (e.g. page loads of the product information webpage) is used as a non-pay-for-performance measure. In some embodiments, the amount of time since a product (and its product information) has been published (or made available to sell on the e-commerce website) is used as a non-pay-for-performance measure. In some embodiments, a rating of the seller that published the product information is used as a non-pay-for-performance measure. In some embodiments, the activity level of the seller is used as a non-pay-for-performance measure. In some embodiments, a non-pay-for-performance measure comprises a rating of the product. In some embodiments, a non-pay-for-performance measure of a product includes the number of products sold. Other non-pay-for-performance measures can also be used.

At 614, the one or more pay-for-performance measures and the one or more non-pay-for-performance measures are normalized. Each measure is normalized to an integer value between 0 and a P, where P is a positive integer. Normalization of the measures helps to be able to compare measures with incongruous units.

For example, pay-for-performance lifetime, which is an measure of how long the product has been a pay-for-performance product, would most likely be a rational or proportion less than 1, rat1, since the amount of time the product has been published is greater than or equal to the amount of time the product has been a pay-for-performance product. Then the proportion of time the product has been a pay-for-performance product is multiplied by a set weight coefficient, u1, so that the maximum value of pay-for-performance measure A is 5. The values of pay-for-performance measure A would be in the range of [0, 5].

The other pay-for-performance measures and non-pay-for-performance measures are also normalized to a set maximum value. In some embodiments, the non-pay-for-performance measures that comprise a frequency of actions are normalized according to a pre-determined maximum measure. For example, a non-pay-for-performance measure is a frequency of accesses of the product information page, and a high frequency of accesses is considered to be 10,000 page views within the history of the product on the e-commerce website. Therefore, if a product has 300 page views, then its frequency of accesses measure is 0.03 (i.e. 300/10,000 max), which is then scaled to the 0 to 5 scale, resulting in a normalized measure of 0.15. In some embodiments, a non-pay-for-performance measure that comprises a frequency is measured over an interval in time. For example, a frequency of page accesses is measured by number of accesses per month, and an average page access per month can be calculated and normalized as a non-pay-for-performance measure. In some embodiments, a time length a product has been published (or made available to be sold on the e-commerce website) is scaled by a pre-determined maximum time length or the maximum time length of any product on the e-commerce website, and then normalized. Other ways of measuring and normalizing the non-pay-for-performance measures that make sense for the metrics and the products on the e-commerce website can be used.

At 616, a content quality score is determined by weighting and combining a pay-for-performance measure and a non-pay-per click measure. In some embodiments, one or more of the determined pay-for-performance measures and one or more of the determined non-pay-for-performance measures is weighted and summed. In some embodiments, the weights for each of the one or more pay-for-performance measures and the one or more non-pay-for-performance measures is predetermined to reflect the goals of promoting pay-for-performance (advertised) products to have a higher content quality score.

The content quality score is a parameter that reflects the importance of several aspects of the product information to the system. The weights are to balance the importance of several aspects of the product information so that the products supplied by superior sellers, product information that is frequently seen by users (i.e., “hotter” products), and products that are more likely to give rise to a transaction are given preference to be selected as a recommended product.

For example, since the pay-for-performance measures indicate the advertised status and popularity of the advertised product (i.e. the amount of fees generated while the product is a pay-for-performance product; and more fees means the pay-for-performance product was clicked or bought a lot) and since advertising is important to the e-commerce website interests, the pay-for-performance measures are allocated a larger weight. The total of all weights is 1.

In some embodiments, the pay-for-performance measures including the amount of time the product has been pay-for-performance and the amount of fees generated are combined to make a single pay-for-performance measure which is then weighted with the non-pay-for-performance measures. For example, the proportion of time the product is a pay-for-performance product is rat1, and the fees generated from the pay-for-performance product within the time length that the product is a pay-for-performance product is m1. Then one value, a pay-for-performance contribution measure C, is calculated by C=rat1*u1+m1*u2, where u1 and u2 is a set weight coefficient. Therefore, the two pay-for-performance measures are weighted and normalized to one pay-for-performance contribution measure. The pay-for-performance contribution measure also has values from 0 to 5.

An embodiment of the content quality score calculated with one or more pay-for-performance measures and one or more non-pay-for-performance measures and their weights is summarized below in Table 2.

TABLE 2

| Measure | Normalized Value | | Weight |
|---|---|---|---|
| Pay-for-performance | C, where C has a range of | [0.5] | u1 |
| contribution | | | |
| Quality of product information | Q, where Q has a range of | [0.5] | u2 |
| score | | | |
| Frequency accesses of product | F, where F has a range of | [0.5] | u3 |
| information | | | |
| Time length since publication | T, where T has a range of | [0.5] | u4 |
| of a product | | | |
| Seller rating | SR, where SR has a range of | [0.5] | u5 |
| Seller activity level | SA, where SA has a range of | [0.5] | u6 |

The normalized measures are weighted and summed in order to determine the content quality score for a product. For example, using Table 2 above, the content quality score is: C*u1+Q*u2+F*u3+T*u4+SR*u5+SA*u6.

In the same way, content quality scores are calculated for other products. In some embodiments, the combination of the one or more pay-for-performance measures and the one or more non-pay-for-performance measures used to calculate the content quality score is different for different categories. In some embodiments, the weights for the one or more pay-for-performance measures and the one or more non-pay-for-performance measures used to calculate the content quality score is different for different categories. For example, a book may have a lower weight on the time length of the product since it has been published, because a book generally takes a longer time to be out of date, than a DVD player that goes out of date quickly.

The content quality score is then ranked within the selected one or more categories the user currently has interest in and supplemental products are chosen, so that a user may have a set of recommended products that are useful or more likely to be clicked on or purchased, at the same time featuring pay-for-performance products.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for determining products to recommend to a user, comprising:
determining, using a processor, information about a product a user is currently interested in;
determining one or more correlated products, wherein the one or more correlated products are correlated to the product the user is currently interested in;
determining whether a number of the one or more correlated products is less than a number of recommended products needed;
in the event that the number of one or more correlated products is less than the number of recommended products needed, determining one or more supplemental products, wherein the one or more supplemental products are determined based at least in part on a pay-for-performance measure based on pay-for-performance information and a non-pay-for-performance measure not based on pay-for-performance information; and
forming a set of recommended products by including the one or more correlated products and the one or more supplemental products;
outputting information pertaining to the set of recommended products.

2. The method as in claim 1, wherein in the event that the number of one or more correlated products is not less than the number of recommended products needed, forming a second set of recommended products by including the one or more correlated products.

3. The method as in claim 1, wherein determining information about a product the user is currently interested in is based on a browsing history of the user on a website.

4. The method as in claim 1, wherein the determined one or more correlated products comprise products that have a high correlation factor.

5. The method as in claim 1, wherein determining one or more supplemental products further comprises determining one or more categories that the user is currently interested in.

6. The method as in claim 5, wherein determining one or more supplemental products further comprises selecting one or more supplemental products from the determined one or more categories that the user is currently interested in.

7. The method as in claim 5, wherein determining one or more categories that the user is currently interested in comprises determining a category user interest score for each category.

8. The method as in claim 7, wherein determining a category user interest score for each category comprises:
dividing a browsing history of the user into time segments;
determining a user interest score for each time segment and for each category based on the browsing history of the user; and
summing the user interest score for each category over the time segments to obtain the category user interest score.

9. The method as in claim 8, wherein the user interest score for each category and for each time segment is based on a number of occurrences of each type of user browsing activity and a weight for each type of user browsing activity.

10. The method as in claim 8, wherein the user interest score for each time segment and for each category is further weighted with an exponential time decay function.

11. The method as in claim 8, wherein the user interest score for each time segment and for each category is filtered by a threshold before summing the user interest score into a category user interest score.

12. The method as in claim 1, wherein determining one or more supplemental products further comprises determining a content quality score for an available product.

13. The method as in claim 12, wherein the content quality score comprises a weighted sum of the pay-for-performance measure and the non-pay-for-performance measure.

14. The method as in claim 1, wherein the pay-for-performance measure comprises one or more of the following measures: a proportion of time an available product has been a pay-for-performance product or fees generated by a pay-for-performance product.

15. The method as in claim 1, wherein the pay-for-performance measure is given a higher weight than the additional non-pay-for-performance measures.

16. The method as in claim 1, wherein the additional non-pay-for-performance measure comprises one or more of the following: a score of quality of an available product's product information, a frequency of accesses of an available product's product information, amount of time since an available product's product information has been published, a seller rating, or a seller activity level.

17. The method as in claim 1, wherein outputting information pertaining to the set of recommended products further comprises formatting product information into a JavaScript Object Format and sending the formatted product information to a web browser to be displayed.

18. A system for determining products to recommend to a user comprising:
one or more processors configured to:
determine information about a product a user is currently interested in;
determine one or more correlated products, wherein the one or more correlated products are correlated to the product the user is currently interested in;
determine whether a number of the one or more correlated products is less than a number of recommended products needed;
in the event that the number of one or more correlated products is less than the number of recommended products needed, determine one or more supplemental products, wherein the one or more supplemental products are determined based on a pay-for-performance measure based on pay-for-performance information and an additional non-pay-for-performance measure not based on pay-for-performance information;
form a set of recommended products by including the one or more correlated products and the one or more supplemental products;
output information pertaining to the set of recommended products to the user; and
one or more memories coupled to the one or more processors configured to provide instructions to the one or more processors.

19. A computer program product for determining products to recommend to a user, the computer program product being embodied in a tangible computer readable storage medium and comprising computer instructions for:
determining information about a product a user is currently interested in;
determining one or more correlated products, wherein the one or more correlated products are correlated to the product the user is currently interested in;
determining whether a number of the one or more correlated products is less than a number of recommended products needed;
in the event that the number of one or more correlated products is less than the number of recommended products needed, determining one or more supplemental products, wherein the one or more supplemental products are determined based on a pay-for-performance measure based on pay-for-performance information and a non-pay-for-performance measure not based on pay-for-performance information;
forming a set of recommended products by including the one or more correlated products and the one or more supplemental products; and
outputting information pertaining to the set of recommended products to the user.

20. A method for determining products to recommend to a user, comprising:
determining, using a processor, information about a product a user is currently interested in;
determining one or more supplemental products, wherein the one or more supplemental products are determined based at least in part on a pay-for-performance measure based on pay-for-performance information and a non-pay-for-performance measure not based on pay-for-performance information; and
outputting information pertaining to the one or more supplemental products.
